(19) United States
(12) Patent Application Publication
(10) Pub. No.: US 2012/0113824 A1
(43) Pub. Date: May 10, 2012

(54) REPORT SEQUENCE WITH PERFORMANCE DATA TRANSMITTED BETWEEN TWO NODES OF A COMUNICATION SYSTEM

(75) Inventor: Andreas OLSSON, Stockholm (SE)

(73) Assignee: TELEFONAKTIEBOLAGET L M ERICSSON (pub), Stockholm (SE)

(21) Appl. No.: 12/940,532

(22) Filed: Nov. 5, 2010

(51) Int. Cl. H04L 12/26

(52) U.S. Cl. 370/252

(57) ABSTRACT

The invention relates to a method, a performance data transmission device and a computer program product for performing performance management reporting from a first to a second node in a communication system. The reporting concerns communication over one communication interface of a node in the communication system and the performance data transmission device comprises a data collecting unit that obtains performance data relating to the communication over the communication interface for transmission to the second node and configuration data, a data scheduling unit that schedules the transmission of performance data and configuration data in a sequence of consecutive reports according to a reporting scheme, where the sequence makes up a set of reports, and a transmitting unit that transmits the reports according to the reporting scheme and where configuration data is only present in a subset of the set of reports including at least one report.

### TECHNICAL FIELD

The invention generally relates to communication networks. More particularly, the invention relates to a method, a performance data transmission device and a computer program product for performing performance management reporting from a first to a second node in a communication system.

### BACKGROUND

In communication networks it is today important to monitor the performance and to manage communication via a communication interface to the communication network based on this monitored performance, especially when the communication interface is an aerial interface of a cellular network. This is done for monitoring the performance of the end-user services, network elements, to identify bottlenecks and to take appropriate actions to battle poor quality. In order to perform the management it is then of importance that performance data concerning this interface is reported. The reporting is then typically made from one node to another node in the system, for instance from a device in the system providing the communication interface to another device in the system, for instance a device at a higher hierarchical level. One example is here from a base station to a system or network managing device.

This type of reporting is today not performed with any real economy in the data transfer, because it is often vital that such information is transmitted regularly and in a way so that correlation of data is kept to a minimum. Then the bandwidth of the system has often also been considered to be so high that the reporting structure has not been seen as any real or relevant limitation.

One way of performing reporting is for example described in US 2009/0036092, where a subscription-based measurement concept is used. Here detailed parameters for a certain measurement report are set by a measurement provider, i.e. a radio base station, instead of a measurement requester. For this purpose the measurement provider “publishes” a certain set of measurements that controller units for radio resource management (RRM) can subscribe to. The parameters are defined in detail in the measuring entity, i.e. a target radio base station, as opposed to being defined by the requesting entity, i.e. an RRM controller. The technique described here has many merits, where one is that it reduces resource consumption for measurement handling. However, it is not evident if there is any reduction of data in the reporting between the two nodes.

Many systems such as for instance Long Term Evolution (LTE) can have many radio bearers with which a mobile station or User Equipment (UE) communicates with a base station of the system. In LTE a base station is typically named eNodeB. One UE can here have up to 16 simultaneous radio bearers (ERABs—EUTRAN Radio Access Bearer).

This is in order to allow different applications to be treated differently in the radio systems dependent on their need for characteristics. Since a base station furthermore can communicate with several mobile stations, this means that the amount of reporting needed to other network devices, such as to higher hierarchical levels can be considerable.

Even though the bandwidth is high in such a system as compared with the bandwidth of an aerial interface, the systems tend to get increasingly complex and require more and more information to be transferred. It is thus of interest to limit the communication also between nodes within the system. Another reason for limiting the communication is that unnecessary communication will lead to unnecessary energy consumption.

There is thus a need for reducing the amount of data communicated in performance management reporting. However, this should not jeopardize the proper functionality of the system. It is for instance still important that measurements are provided regularly so that correct decisions regarding various control activities in the system can be made.

It would thus be of interest to limit the data reported from one system node to another system node.

Schemes for limiting communication concerning performance management have previously been described in relation to the aerial interface, i.e. in relation to the interface between the system and end-users.

U.S. Pat. No. 6,445,917 does for instance describe event-based or event driven reporting of mobile station measurements from a mobile station to a radio access network. Here the mobile station measures one or more radio-related parameters for one or more cells, evaluates these parameters with respect to a predetermined condition or event and determines that the predetermined condition is satisfied or that the event has occurred. Based on that evaluation, the mobile station sends a report to the radio access network. Accordingly, the occurrence of an event and/or the satisfaction of a condition triggers the sending of the report to the network.

US 2007/0149228 describes how a wireless terminal reports information to a serving base station according to a reporting schedule. The reporting schedule includes a plurality of different types of fixed type information reports which communicate information of a type dictated by the reporting schedule. The reporting schedule also includes flexible reports at predetermined locations within the reporting schedule. The wireless terminal selects the type of report to be communicated in the flexible report. Information identifying the wireless terminal's report type selection for the flexible report is jointly coded along with the report body information and communicated in the same dedicated control channel segment. The reporting schedule repeats over time.

These schemes are more or less strongly tied to the aerial interface and cannot easily be applied on the communication between the nodes of the network.

There therefore still exists a need for limiting the amount of data transferred between two nodes of a communication system in relation to performance management reporting while at the same time ensuring regular reporting.

### SUMMARY

One object of the invention is thus to limit the amount of data transferred between two nodes of a communication system in relation to performance management reporting while at the same time ensuring regular reporting.

The general idea of the invention is that the data in a report can be divided into performance data and configuration data, where performance data has to be sent frequently and configuration data can be sent infrequently for instance only when changed.

The object is according to a first aspect of the invention achieved through a method for performing performance management reporting from a first to a second node in a communication system, where the performance management reporting concerns communication over at least one communication interface of a node in the communication system, and the method comprises the steps of:

obtaining performance data relating to the communication over the communication interface, obtaining configuration data,
scheduling the transmission of performance data and configuration data in a sequence of consecutive reports according to a reporting scheme where the sequence makes up a set of reports, and
transmitting the reports according to the reporting scheme,
wherein configuration data is only present in a subset of the set of reports, which subset includes at least one report.

The object is according to a second aspect of the invention achieved through a performance data transmission device provided in a first node of a communication system for performing performance management reporting to a second node in the communication system, where the performance management reporting concerns communication over at least one communication interface of a node in the communication system, the performance data transmission device comprising

a data collecting unit configured to obtain performance data relating to the communication over the communication interface for transmission to said second node and configuration data,
a data scheduling unit configured to schedule the transmission of performance data and configuration data in a sequence of consecutive reports according to a reporting scheme, said sequence making up a set of reports, and
a transmitting unit configured to transmit the reports according to the reporting scheme,
wherein configuration data is only present in a subset of the set of reports, which subset includes at least one report.

The above-mentioned object is according to a third aspect of the invention achieved through a computer program product for performing performance management reporting from a first to a second node in a communication system, where the performance management reporting concerns communication over at least one communication interface of a node in the communication system and the computer program product comprises computer readable means comprising computer program code which when run on a processor of a performance data transmission device in the first node causes the performance data transmission device to:

obtain performance data relating to the communication over the communication interface,
obtain configuration data,
schedule the transmission of performance data and configuration data in a sequence of consecutive reports according to a reporting scheme, where the sequence makes up a set of reports, and
transmit the reports according to the reporting scheme, where configuration data is only present in a subset of the set of reports, which subset includes at least one report.

The invention has many advantages. It diminishes the size of the reports in the sequence, which lowers the amount of data transferred and the required storage space. This also reduces energy consumption. At the same time the invention also ensures that the vital measurement data is transferred regularly so that the control activities described above can still be safely made.

According to one variation of the invention the method comprises the further steps of grouping the configuration data into static and semi-static configuration data and transmitting, upon a change in the semi-static configuration data, a report comprising a set of configuration data, which set of configuration data only includes semi-static configuration data.

According to this variation of the invention the performance data transmission device further comprises a data grouping unit configured to group the configuration data into static and semi-static configuration data and the data scheduling unit is configured to, upon a change in the semi-static configuration data, schedule the transmission of a report comprising a set of configuration data, which set of configuration data only includes semi-static configuration data.

According to the same variation of the invention the computer program code of the computer program product further causes the processor of the performance data transmission device to group the configuration data into static and semi-static configuration data and transmit, upon a change in the semi-static configuration data, a report comprising a set of configuration data, which set of configuration data only includes semi-static configuration data.

According to another variation of the invention the method comprises the further step of transmitting a report comprising a set of configuration data only including semi-static configuration data in addition to the transmission of reports in said sequence.

According to the same variation of the invention the data scheduling unit is configured to schedule the transmission of the report with a configuration data set only comprising semi-static configuration data in addition to the transmission of reports in the sequence and the transmission unit is configured to transmit also this report.

According to the same variation of the invention the computer program code of the computer program product further causes the processor of the performance data transmission device to transmit a report comprising a set of configuration data only including semi-static configuration data in addition to the transmission of reports in the sequence.

According to another variation of the invention one report in the sequence comprises exhaustive time data. Here it is possible that other reports in the sequence lack such exhaustive time data and instead comprise a reference to this report, which reference provides a time offset from the exhaustive time data.

According to another variation of the invention one or more reports in the subset together comprise a complete set of configuration data associated with the starting of transmission of the sequence.

According to yet another variation of the invention the method comprises the further step of grouping the performance data according to dynamic and semi-dynamic performance data and the step of transmitting according to the reporting scheme comprises only transmitting semi-dynamic performance data having changed compared with previous reports in the sequence.

According to the same variation, the data grouping unit is further configured to group the performance data according to dynamic and semi-dynamic performance data and the data scheduling unit is further configured to only schedule transmission of semi-dynamic performance data having changed compared with previous reports in the sequence.

According to the same variation of the invention the computer program code of the computer program product further causes the processor of the performance data transmission device to group the performance data according to dynamic and semi-dynamic performance data and only transmit semi-dynamic performance data having changed compared with previous reports in the sequence transmit when transmitting reports according to the reporting scheme.

According to a further variation of the invention dynamic performance data comprises interface measurement data and that is present in every report in the sequence.

According to yet another variation of the invention the semi-dynamic performance data comprises control function data varying only in relation to the performing of a control activity in relation to the communication interface.

According to yet another variation of the communication system is a wireless communication system, the at least one interface comprises the wireless interface of a base station in the system and the reports are provided in a report sequence associated with a communication entity of the wireless interface. Here a communication entity can be a mobile station, a carrier or a cell.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings, in which:

FIG. 1 schematically shows a mobile station and a communication system including an number of devices, where the mobile station communicates with a first base station of the communication system,

FIG. 2 shows a simplified block schematic of a performance data transmission device according to the invention,

FIG. 3 schematically shows the structure of a full report being reported by the first base station,

FIG. 4 shows a number of sequential reports being sent by the base station and their relationship in size as well as a further report sent in addition to the sequence,

FIG. 5 shows a flow chart of a number of steps in a method for transmitting system performance data being performed by the first base station, and

FIG. 6 schematically shows a computer program product according to an embodiment of the invention in the form of a CD ROM disc on which a computer program of the invention is provided.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary detail.

The invention is generally directed towards reporting of system performance data relating to a communication interface of a node in the communication system. The system performance data is furthermore provided in relation to a communication entity of the interface, where the communication entity is either a device communicating via the interface, such as a mobile station or an element of the interface, such as a cell or a carrier. This interface may furthermore be an interface via which terminals or end-user devices access the communication system. It may thus be a system access interface.

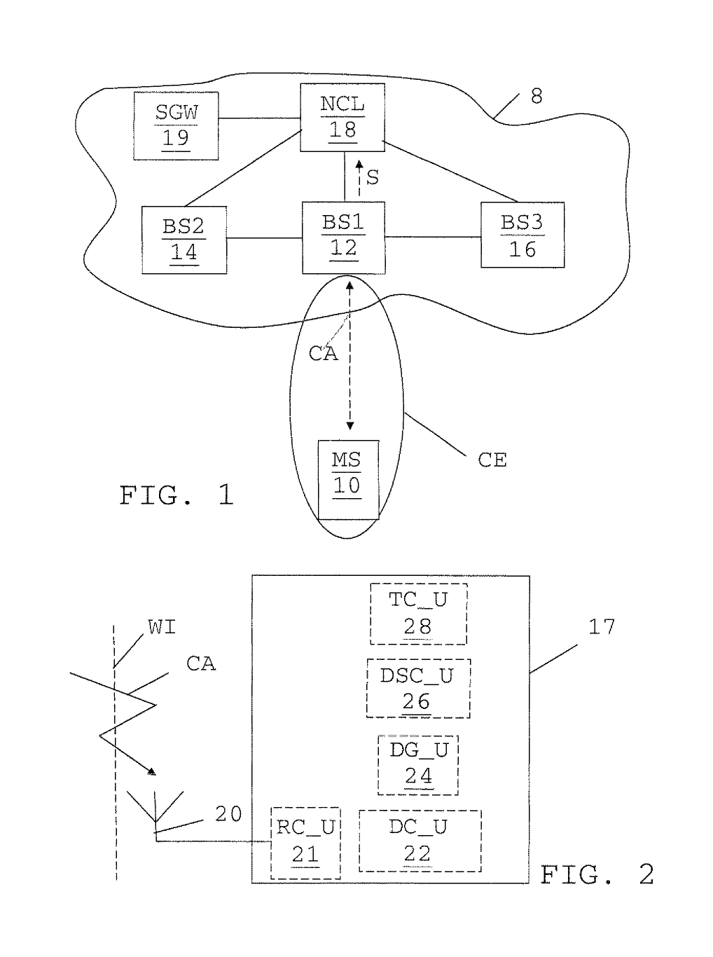

FIG. 1 schematically shows a communication system 8 in which the invention can be provided. The system 8 is in a first embodiment of the invention a Wide Area Network (WAN) system. This system 8 may here be a cellular system such as a Universal Mobile Telecommunications System (UMTS) or a Long Term Evolution (LTE) system. However it may also be a landline system or a computer communication system, such as a local area network (LAN) or a wireless local area network (WLAN) system. To the system 8 there is connected a mobile station MS 10, which in the present example is a cellular phone. A cellular phone is merely one example of a mobile station that can communicate with the system 8. Other types of devices are computers like lap top computers, desk top computers or palm top computers and digital organizers. These are just some types of devices, here end-user devices, that may communicate with the system 8. A mobile station is in these circumstances also often denoted User Equipment (UE).

In the communication system 8 there is a first, second and third base station BS1 12, BS2 14 and BS3 16. These all cover at least one cell each. In FIG. 1 only one such cell CE is shown in order to simplify the understanding of the present invention. This shown cell CE is furthermore a cell provided by the first base station 12. It should thus be understood that some or all base stations could provide more than one cell. It should furthermore be realized that the system 8 may include more base stations. A base station is in LTE often denoted eNodeE.

All base stations 12, 14 and 16 furthermore communicate with a device at a higher hierarchical level in the system 8. The base stations 12, 14 and 16 can also communicate with each other, i.e. on the same hierarchical level. In LTE it is possible to use a so-called X2 interface or a so-called S1 interface. The device on the higher hierarchical level is here a system or network control device NCL 18. The device can furthermore be an operational support system (OSS) device. In the system 8 there is shown a further device 19 that can also communicate with the network control device 18. This further device 19 is in this example a serving gateway SGW. The further device can in LTE as an alternative be a Mobile Management Entity (MME). Corresponding entities to above mentioned interfaces and MME could of course be used in case the system was a GSM or UMTS system.

In the cell CE there is shown the mobile station 10 communicating with the first base station 14 via a carrier CA.

The first base station 12 thus has a communication interface, which in this case is an aerial or wireless interface via which one or more cells and one or more carriers within each cell are provided. It should here be realized that the first base station 12 can communicate with more mobile stations than the one shown.

The first base station 12 is in the first embodiment of the invention furthermore equipped with an integral performance data transmission device and acts as a first node of the system. The first base station 12 communicates with a second node of the system, where the network control device 18 in this first embodiment is the second node. In other variations of the invention the further device 19 may be equipped with a performance data transmission device provided in relation to an aerial interface of the first base station 12. In still other variations of the invention the second base station 14 may act as the second node with the first mobile station being equipped with a performance data transmission device, where the second node may in turn communicate with the network control device. The second base station may also be equipped with a the performance data transmission device provided in relation to the communication interface of the first base station, which may be the aerial interface of the first base station. When two base stations are communicating with each other they may furthermore use their aerial interfaces.

FIG. 2 shows a block schematic of a performance data transmission device 17 that is integrated in parts of the first base station

There is here an antenna 20 connected to a radio communication unit RC_U 21. There is furthermore a data collecting unit DC_U 22, a data grouping unit DC_U 24, a data scheduling unit DSC_U 26 and finally a transmitting unit TC_U 28. The radio communication unit 21 is provided for modulating and demodulating data on carriers CA sent and received via the antenna 20. The antenna 20 and radio communication unit 21 therefore provides the above-mentioned communication interface of the first base station 12, which interface is an aerial or wireless interface WI. The transmitting unit 28 is in turn provided for communication with other devices of the communication system 8, and especially for communication with the network control device 18 internally in the system for instance using an X2 interface.

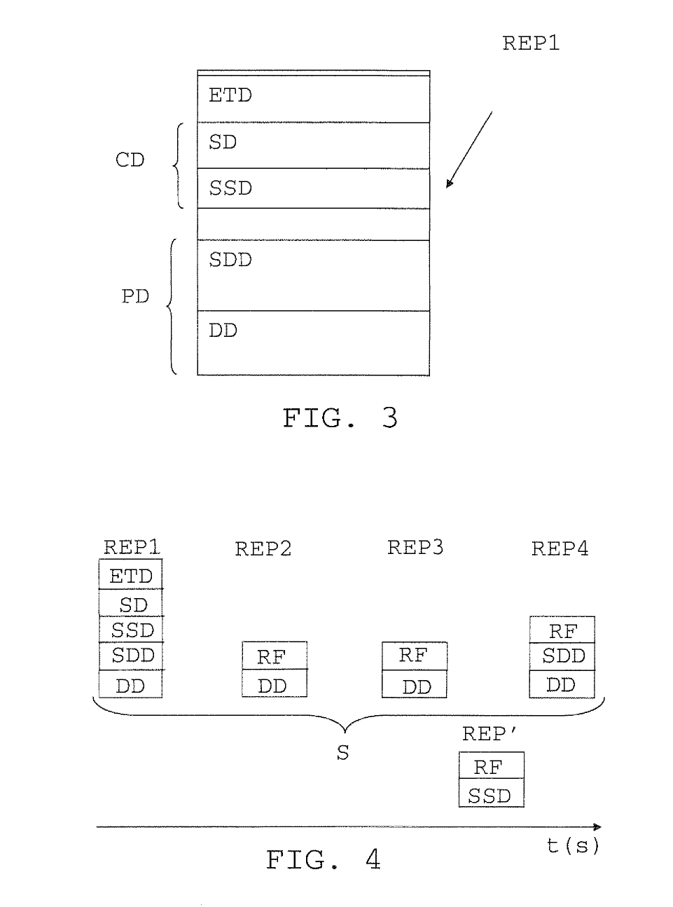

In the communication with the network control device 18, the performance data transmission device 17 sends performance data reports. One first exemplifying such report REP1 is schematically outlined in FIG. 3. This report REP1 includes configuration data CD and performance data PD. The configuration data CD furthermore comprises static configuration data SD and semi-static configuration data SSD. The performance data PD of the first report REP1 furthermore comprises dynamic performance data DD and semi-dynamic performance data SDD. The first report REP1 finally includes exhaustive time data ETD.

The configuration data CD includes such data as configuration data concerning or relating to the communication over a communication interface like identifiers of the entities with which the performance data reporting is concerned, such as identities used in the communication over the communication interface, here the wireless interface, like mobile station identity, carrier identity and cell identity, t. Other examples of configuration data is radio link related data such as rate shaping and cell related data such maximum downlink output power, maximum uplink output power and bandwidth. The configuration data may also include configuration data concerning the transmission of the reports, such as identities of the nodes between which the system performance data in the reports are sent and the rate at which a sequence of reports is sent. Some of the configuration data is invariable and never changes, but some other data is variable and can change, however relatively infrequently. The dynamic performance data PD includes data concerning the quality of communication of the communication interface, such as the quality of communication of a certain carrier. This data can be measurement data such as signal strength measurement data, bit error rate and number of data packets received over the communication interface. It can also be data such as the number of received packets. The semi-dynamic performance data comprises control function data such as data about decisions that have been taken, causes of decisions and how successful these decisions have been, where the decisions may involve decisions concerning handover between cells and carriers. The configuration data of the first report REP1 is in the first embodiment a complete set of configuration data for the above-mentioned reports. This means that the configuration data of the first report REP1 includes all data needed for specifying the environment to which the performance data belongs, i.e. all data for specifying to which part of the communication interface the performance data belongs, from where the performance emanates, which entity is to have the performance data and in perhaps also relation to what task to be performed in the network. Performance data can also include data such as modulation method, code rate and MIMO (Multiple Input Multiple Output) mode.

This first report REP1 is part of a report sequence. FIG. 4 schematically shows such a sequence S of reports sent regularly over time from the performance data transmission device 17 and in this first embodiment destined for the network control device. There is here shown the first report REP1 with the Exhaustive time data ETD, static configuration data SD, semi-static configuration data SSD, semi-dynamic performance data SDD and dynamic performance data DD. There is also shown a second report REP2 including a reference RE and dynamic performance data DL. This is followed by a third report REP3 also including a reference RF and dynamic performance data DD. Finally the sequence S comprises a fourth report REP4 including a reference RF, semi-dynamic performance data SDD and dynamic performance data DD. In FIG. 4 there is also a further report REP′ sent between the third and fourth reports REP3 and REP4 of the sequence. This further report REP′ also includes a reference RE as well as semi-static configuration data SSD.

The reference is used to link the data of a report to the configuration data of the sequence. The reports may furthermore include a sequence indicator indication their position in the sequence. This sequence indicator could be a part of the reference RE. The sequence indicator could as an alternative be a part of dynamic performance data. It could for instance be a number of least significant bits of the first measurement values provide din the reports.

As can be seen the reports in the exemplifying sequence S of FIG. 4 are sent at a certain same rate. The reports of the exemplifying sequence S are thus sent at equidistant points in time. There is thus a time interval between two consecutive reports in the exemplifying sequence and this time interval is the same throughout the sequence. It can thus be seen that the reports follow a reporting scheme, which reporting scheme in this example indicates that the reports of the sequence should be consecutive and sent regularly with a common time interval between the reports. However, it can also be seen that the size of the reports differ. The reports of the invention thus include varying amounts of data.

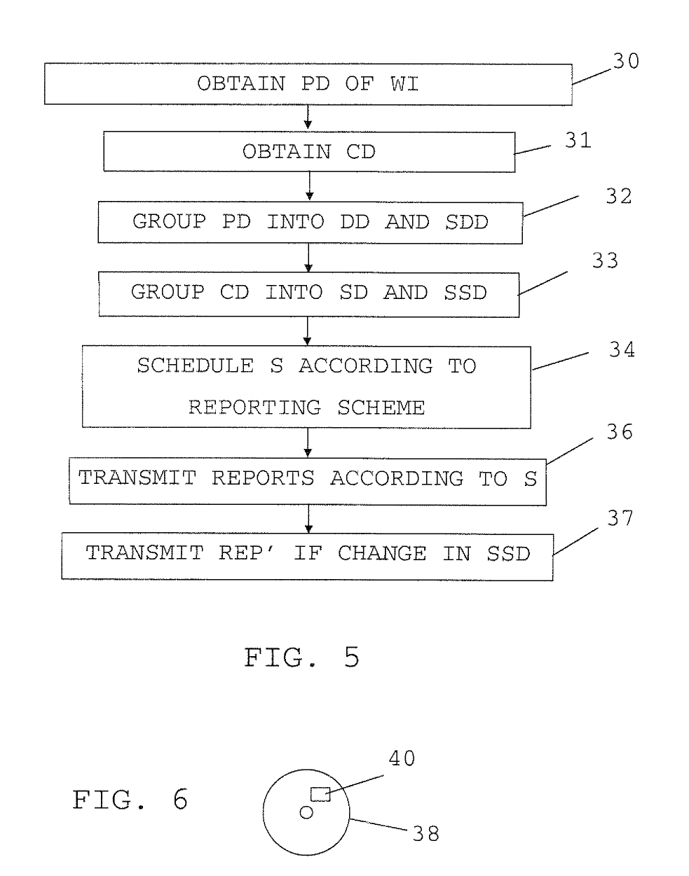

The functioning of the first base station when acting as a performance data transmission device 17 will now be described in more detail with reference being made to the previously described FIGS. 1-4 as well as to FIG. 5, which shows a flow chart of a number of method steps being taken in a method for transmitting system performance data, which method is performed by the performance data transmission device 17.

Performance management of communication systems has always been a very important part of network operations.

The schemes used so far for performance management in systems like Global System for Mobile Communications (GSM) and Wideband Code Division Multiple Access/High Speed Packet Access (WCDMA/HSPA) have been based on a combination of counters and trace functions.

In performance management there is an inherent trade off between the granularity or resolution of the performance information and the amount of performance management related data that needs to be sent from a node, such as the first base station.

Counters have the lowest resolution in that they aggregate a lot of information into a single number. A counter can as an example indicate the total number of dropped calls in a cell.

Tracing functions have the highest resolution in that lots of information about a single mobile station is recorded and sent to the network control device. In contrast to a counter a tracing function can, in relation to the above mentioned dropped call example, capture for instance when and why a mobile station dropped its calls. This is often designated an event, where an event can be seen as a report that can contain information about a single happening or a summary over a limited time period. In service assurance and performance monitoring event reporting techniques have become more and more popular, sometimes at the expense on the use of counters.

For Traces the base station is nowadays implementing events on mobile station and Radio Bearer level and these events are typically reported every ˜1 s (i.e. some events are reported for every mobile station every second and some for every radio bearer every second). However, these events take quite a lot of disc space and transmission resources. If for instance 3000 mobile stations are connected to a base station that generates 5 events per mobile station with an estimated average event size of 50 Bytes the following relationships are obtained:
3000*5*50*8/1024˜5 Mbps/s is needed in transmission bandwidth and
3000*5*50*8/1024*60*15*4-18 GB storage needed if the base station has to store these events for 1 hour.

It would thus be of interest to reduce this bandwidth and storage requirements, which is the object of the present invention.

The network control device 18 is responsible for performance management and is therefore also among other things responsible for receiving data about the communications of the cell CE, the carriers CA as well as mobile stations 10 with which the base stations 12, 14 and 16 communicate. This is used for such things as hand over.

However, in order to perform these activities it has to be supplied with performance data.

The first base station 12 acting as a performance data transmission device 17 therefore performs performance management reporting to the network control device 18, where the reporting concerns communication over a communication interface of a node in the communication system. In this first embodiment the node having this communication interface is furthermore provided by the first base station 12. The performance data transmission device 17 therefore reports such data in a number of report sequences S, where there may be a number of cell report sequences, one for each cell handled by the first base station, a number of carrier report sequences corresponding to the amount of carriers handled by the first base station as well as a number of mobile station report sequences, one or more for each mobile station connected to the first base station. All these are reported to the network management device at various rates. However, the report sequences are all set up according to the same principle and therefore these reports will in the following be exemplified by one such report sequence S, which in this present example is a report sequence related to one mobile station 10 with which the performance data transmission device 17 is communicating via the communication interface WI provided via the antenna 20.

The performance data transmission device 17 will first of all initiate an event tracing function, where the event in the present example may be the connection of a mobile station to the first base station, for instance through roaming into the cell C. The initiation of the event trace function is more particularly performed by the data collecting unit 22. One example of another activity that may cause the generation of a trace event is the setting up of a communication session between the mobile station and another device via the first base station. The event thus causes the generation of a sequence S of reports.

In order to be able to transfer data necessary for the reports, the data collecting unit 22 then obtains necessary performance data PD relating to communication over the wireless interface WI, i.e. performance data providing characteristics of the communication over the interface, step 30. In doing this it may collect or receive performance data PD of the communication interface WI. This data may comprise measurement data of the interface. Such measurement data may be measured by the mobile station and reported via the interface. It may also be data measured by the base station. Measurement data can here be signal strength measurements, signal to interference measurements, bit error rate, delay, number of received packets etc. Other data that is obtained is process control data, such as status data in relation to a command, a request for the performance of a command, an acknowledgement of a received command, the causes for issuing a certain command and the results of a performed command. The data collecting unit 22 also obtains configuration data CD, step 31. It may thus collect or receive configuration data CD. One item of configuration data is the identity of the mobile station 10, which may be collected or received via the antenna 20 and radio communication unit 21. Other items of configuration data are the cell identity of the cell the mobile station is located in and carrier identities of carriers used for the communication with the mobile station. These identities may be collected from within the base station, for instance through a memory associated with the radio communication unit 21. It may also be necessary to obtain the identity of a node in the system that is to receive the reports, here the network control device 18, as well as the identity of the performance data transmission device 17 itself within the communication system 8. This data may be collected or received via the transmission control unit 28. The data may furthermore in many cases have been received before the trace function is activated. Finally the data collecting unit 22 also obtains time data in the form of a time stamp or global time reference, here in the form of a time stamp indicating hours, minutes and seconds and possibly also milliseconds. This time stamp can be generated by a timing unit of the first base station. It can also be received from time keeping unit of the system. The obtained data is then forwarded from the data collecting unit 22 to the data grouping unit 24.

The data grouping unit 24 then groups the performance data PD into dynamic and semi-dynamic performance data DD and SDD, step 32, where dynamic data is data being changed regularly and semi-dynamic data is data changed only occasionally. Here the measurement data is dynamic data, which may be measured regularly for instance at fixed time intervals, while the control function data is typically semi-dynamic data that may be changed seldom and unregularly. The semi-dynamic data is with advantage obtained based on a separate event such as the performing of an action or a command in the system like a handover. The data grouping unit 24 furthermore groups the configuration data into static configuration data SD and semi-static configuration data SSD, step 33, where static configuration data SD never changes, while semi-static configuration data SSD can change more seldom. Semi-static data can here be an identity or part of an identity, which changes, for instance because of some activity being performed in the network or base station, like the change of a carrier used by a mobile station. It can thus be changed because of an event occurring in for instance the first base station.

Here the time data like a time stamp is considered to be exhaustive time data ETD, which is used as an absolute time reference. It is here exhaustive time data because this data includes all the time information needed by the receiving node, here the network control device 18, for determining the time of the first report REP1. Also this data can be considered static data. However all or some of it may be considered semi-static.

After this grouping has been performed, the data scheduling unit 26 then schedules the transmission of performance data and configuration data in the sequence S in consecutive reports according to the reporting scheme S, step 34, whereupon the transmission control unit 28 transmits the reports according to the scheme, step 36. The sequence S here makes up a set of reports.

According to the exemplifying scheme of FIG. 4, the data scheduling unit 26 schedules the sending of a first report REP1 in the sequence S. According to the scheme of this first embodiment, the first report REP1 comprises all the static, semi-static, semi-dynamic and dynamic data SD, SSD, SDD, DD as well as the exhaustive time data ETD at hand at the time of transmission of the first report REP1, i.e. at the time of initiation of the transmission of the sequence S. Since it includes all static and semi-static configuration data, the first report REP1 includes a complete set of configuration data associated with the starting of transmission of the sequence.

According to the invention the configuration data is only present in a subset of the set of reports, which subset includes at least one report and in the first embodiment only one report, the first report REP1.

Therefore later reports REP2, REP3 and REP4 in the sequence S do according to the scheme not include all the above-mentioned information. In this first embodiment they do however always include the dynamic data DD and only semi-dynamic data SDD when, an event causes the semi-dynamic data SDD to be changed and in this first embodiment also never any static data SD. According to this first embodiment a second report REP2 sent at a later point in time here only includes the dynamic data DD together with a reference RD, which is a reference to the full report REP1 and here also to the exhaustive time data ETD. For this reason the reference RF may be a counter number. Based on this reference it is then possible that the environment in which the data of the second report REP2 belongs can be determined, which environment is typically determined by the configuration data. This reference RF can then be used to indicate the number of a specific report in the sequence and therefore at the same time provide the time of the measurement of the dynamic data. It is therefore possible to obtain a complete time stamp based on this reference. These other reports REP2, REP3 and REP4 thus lack exhaustive time data and instead use the reference also as a reference to the exhaustive time data of the first report REP1, where the reference thereby provides an offset to the exhaustive time data. This means that the reference may also include time data indicating the second and millisecond parts of the time stamp. It is here noted that the semi-dynamic performance data is not included in the second report REP2. This type of data is only transmitted in relation to the change in status, such as caused by an event or caused by the performing of an activity in relation to a command, such as the performing of a handover. Unless a command is imminent this type of data is not being sent. This means that before the further report is sent, the data collecting unit 24 had received a changed status indication that signals new semi-dynamic performance data and included it in the fourth report. Semi-dynamic performance data is thus only transmitted if there is a change compare with the previous reports, and here a change as compared with the status in the first report.

As can be seen in FIG. 4 a third report REP3 looks the same as the second report REP2, while a fourth report REP4 includes a reference RF, dynamic performance data DD and semi-dynamic performance data SDD. In the third report REP3, there is no change in control status, while in the fourth report REP4 there is a change in control status.

According to the first embodiment of the invention the data scheduling unit 26 furthermore investigates if there is a change in the semi-static configuration data. If for instance a handover is made to a new carrier for a mobile station and a carrier identifier is changed, this will then cause an event to be generated in the ordinary base station function handling elements of the base station, which event is notified to the data collecting unit 24, which is then informed of or fetches the changed semi-static configuration data, here the changed carrier identifier. The data collecting unit 24 then notifies the data scheduling unit 26, which schedules the transmission of this changed semi-static data outside of the scheme S, i.e. schedules the transmission of a further additional report REP′ in addition to the sequence. The transmission control unit 28 then transmits the further report REP′ outside of the sequence S. The further report REP′ then includes the changed semi-static configuration data and in the present example the new carrier identifier and perhaps which carrier identifier it is to replace as well a reference to the exhaustive time data of the first report REP1 of the sequence. As an alternative the further report can include a complete time stamp, i.e., exhaustive time data defining the time of the further report. This further report REP′ is here shown as being transmitted in a time between the third and the fourth report REP3 and REP4 of the sequence S. The data scheduling unit 26 thus schedules and the transmission control unit 28 thus transmits the further report REP′ if there is a change in the semi-static configuration data SSD, step 37. It can thus be seen that upon a change in the semi-static configuration data, there is sent a report carrying a set of configuration data including semi-static configuration data. Furthermore, in the first embodiment this further report lacks performance data. It should however be realized that may as an alternative also include performance data, for instance semi-dynamic performance data or even dynamic performance data.

In one example of a report sequence which is a traffic report for a carrier and mobile station, the reports could be sent at a rate of 1.28 s. The first report would then have the following data:

EVENT_PARAM_TIMESTAMP_HOUR, the hour part of the exhaustive time data
EVENT_PARAM_TIMESTAMP_MINUTE, the minute part of the exhaustive time data
EVENT_PARAM_TIMESTAMP_SECOND, the second part of the exhaustive time data
EVENT_PARAM_TIMESTAMP_MILLISEC, the millisecond part of the exhaustive time data,
EVENT_PARAM_SCANNER_ID, semi-static data identifies type of performance data,
EVENT_PARAM_RBS_MODULE_ID, static or semi-static data identifying the base station,
EVENT_PARAM_GLOBAL_CELL_ID, static or semi-static data identifying a cell,
EVENT_PARAM_ENBS1APID, semi-static data identifying a mobile station within the base station,
EVENT_PARAM_MMES1APID, semi-static data identifying a mobile station within an MME
EVENT_PARAM_GUMMEI, semi-static data identifying an MME,
EVENT_PARAM_RAC_UE_REF, semi-static data providing an internal identity of a mobile station within a base station,
EVENT_PARAM_TRACE_RECORDING_SESSION_REFERENCE, semi-static data providing an identifier for type of dynamic data,
EVENT_PARAM_BEARER_ID, semi-static data providing a reference for a radio bearer between a base station and a mobile station,
EVENT_PARAM_ERAB_ID, semi-static data providing a reference for a radio bearer used by MME and a base station,
EVENT_PARAM_PER_PDCPVOL_DL_RB, uplink dynamic measurement data,
EVENT_PARAM_PER_PDCPVOL_UL_RB, downlink dynamic measurement data.

As can thus be seen the size of the reports are diminished as is the amount of data transferred. This means that the bandwidth is lowered compared with if every report is a full report. The required storage space is also lowered as is the energy consumption. The invention also ensures that the vital measurement data is transferred regularly so that the control activities described above can still be made.

In the example given above there was a structure used for a sequence related to a mobile station. The same principle can be used for a reporting scheme associated with a specific carrier as well as a reporting scheme for a specific cell.

There are other variations that are possible to make of the invention. The static data can in some cases be scheduled and sent in two or more reports. The static data can in some cases also be changed. In this case a completely new sequence may be sent. It is also possible to send the exhaustive time data in a second report later in the sequence, in addition to sending it in the first report, for instance in order to calibrate the report timing. It is also possible that the exhaustive time data is not present in the first report, but present for the first time in a later report in the sequence. It is also possible that some dynamic data is omitted from a sequence, for instance if it is the same as in a previous report or because of network congestion. In this case a report in the sequence can be omitted, so that there is an increased gap between two consecutive reports. It is furthermore possible that the further report with semi-static data is included in a report in the sequence or that a further report with semi-dynamic performance data is sent outside of the sequence.

The transmission control unit, data scheduling unit, data grouping unit, data collecting unit and radio communication unit may be implemented through hardware.

One or more of the units may also be implemented in the form of one or more computers or servers in the system. Such a computer would then comprise a processor and a program memory, where the memory would include software implementing the functionality of the various units. It should here also be realized that the above mentioned processor may be a single central processing unit, but it can also be distributed and thus that functionality of the performance data transmission device can be implemented via two or more different processor units in the computer. For example, the processor may include general purpose microprocessors, instruction set processors and/or related chips sets and/or special purpose microprocessors such as ASICs (Application Specific Integrated Circuit). The processor may also comprise board memory for caching purposes.

The performance data transmission device can also be provided in the form of software. As mentioned above, it and its units may with advantage be provided in the form of one or more processors with associated program memory including computer program code for performing their functions. However this computer program code can be provided via a computer program, for instance a program on an external server, and then downloaded to the computer which is to act as a performance data transmission device.

The computer program code may also be provided on a computer readable means, for instance a computer readable means in the form of a data carrier, like a CD ROM disc, a flash memory, an EEPROM memory or a memory stick carrying such a computer program with the computer program code, which will implement the function of the performance data transmission device when being loaded into a computer. The invention may thus be provided as a computer program product comprising a computer readable means carrying a program with computer program code. One such computer program product comprising a computer readable means in the form of a CD ROM disc 38 with the above-mentioned computer program 40 is schematically shown in FIG. 6.

There are a number of variations that may be made of the invention apart form those already mentioned. The antenna and radio communication unit could for instance in some variations of the invention be considered to act as a transmitting unit. It is as a variation of the invention also possible with the rate used of transmitting the sequence to be varying. The reports of the sequence can thus be transmitted periodically as well as non-periodic or with varying periodicity. The rate can thus be increased or decreased during transmission. A change in rate could in one variation of the invention be indicated in the semi-dynamic performance data or semi-static configuration data.

The report with a complete set of configuration data was furthermore described as being the first report of the sequence. It should here be realized that it may in fact be a later report in the sequence as well. It is also possible that the complete set of configuration data is divided into several reports. It is for instance possible that some configuration data concerning radio resource control (RRC) establishment for a mobile station between a mobile station and a base station is provided in one report, while configuration data concerned with the establishment of a link between an MME and a base station for a mobile station is provided in another report. It can therefore be seen that one or more reports in a subset of the set of reports together comprise a complete set of configuration data associated with the start of transmission of the sequence, i.e. configuration data initially applicable for the sequence when it is started to be transmitted.

It also should be realized that the monitored communication interface is not limited to being an aerial interface, but other interfaces could be monitored such as X2 or S1 interfaces. It is furthermore possible that a report sequence concerns more than one communication interface such as an aerial interface of a base station as well as an interface, like the X2 interface, between two base stations. Time data in the reports were above described as being a part of the reference to a report comprising a complete set of configuration data. It should be realised that a part of the time data may instead be provided separately from the reference as dynamic data, while other can be considered as semi-dynamic or semi-static time data.

Therefore, while the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims.

1. A method for performing performance management reporting from a first to a second node in a communication system, where the performance management reporting concerns communication over at least one communication interface of a node in the communication system, the method comprising the steps of:
obtaining performance data relating to the communication over the communication interface, obtaining configuration data,
scheduling the transmission of performance data and configuration data in a sequence of consecutive reports according to a reporting scheme, said sequence making up a set of reports, and
transmitting said reports according to the reporting scheme,
wherein configuration data is only present in a subset of the set of reports, which subset includes at least one report.

2. The method according to claim 1, further comprising the step of grouping the configuration data into static and semi-static configuration data and transmitting, upon a change in the semi-static interface communication, a report comprising a set of configuration data, which set of configuration data only includes semi-static configuration data.

3. The method according to claim 2, wherein the step of transmitting a report comprising a set of configuration data only including semi-static configuration data is performed in addition to the transmission of the reports in said sequence.

4. The method according to claim 1, wherein one report in the sequence comprises exhaustive time data.

5. A method according to claim 4, wherein other reports in the subset lack such exhaustive time data and instead comprise a reference to said one report, which reference provides a time offset from the exhaustive time data.

6. The method according to claim 1, wherein one or more reports in the subset together comprise a complete set of configuration data associated with the starting of transmission of the sequence.

7. The method according to claim 1, further comprising the step of grouping the performance data according to dynamic and semi-dynamic performance data, and the step of transmitting according to the reporting scheme comprises transmitting only semi-dynamic performance data having changed compared with previous reports in the sequence.

8. The method according to claim 7, wherein the dynamic performance data comprises interface measurement data and that is present in every report in the sequence.

9. The method according to claim 7, wherein the semi-dynamic performance data comprises control function data varying only in relation to the performing of a control activity in relation to the communication interface.

10. The method according to claim 1, wherein the communication system is a wireless communication system, said at least one interface comprising the wireless interface of a base station in the system and the reports are provided in a report sequence associated with a communication entity of the wireless interface.

11. The method according to claim 10, wherein the communication entity is a mobile station.

12. The method according to claim 10, wherein the communication entity is a carrier.

13. The method according to claim 10, wherein the communication entity is a cell.

14. A performance data transmission device provided in a first node of a communication system for performing performance management reporting to a second node in the communication system, where the performance management reporting concerns communication over at least one communication interface of a node in the communication system, the performance data transmission device comprising
a data collecting unit configured to obtain performance data relating to the communication over the communication interface for transmission to said second node and configuration data,
a data scheduling unit configured to schedule the transmission of performance data and configuration data in a sequence of consecutive reports according to a reporting scheme, said sequence making up a set of reports, and
a transmitting unit configured to transmit said reports according to the reporting scheme,
wherein configuration data is only present in a subset of the set of reports, which subset includes at least one report.

15. The performance data transmission device according to claim 14, further comprising a data grouping unit configured to group the configuration data into static and semi-static configuration data and the data scheduling unit is configured to, upon a change in the semi-static configuration data, schedule the transmission of a report comprising a set of configuration data, which set of configuration data only includes semi-static configuration data.

16. The performance data transmission device according to claim 15, wherein the data scheduling unit is configured to schedule the transmission of said report with a configuration data set only comprising semi-static configuration data in addition to the transmission of reports in said sequence and the transmission unit is configured to transmit also this report.

17. The performance data transmission device according to claim 15, wherein one report in the subset comprises all static and semi-static configuration data at hand at a point in time associated with the starting of transmission of the sequence.

18. A computer program product for performing performance management reporting from a first to a second node in a communication system, where the performance management reporting concerns communication over at least one communication interface of a node in the communication system and the computer program product comprises product comprises computer readable means comprising computer program code which when run on a processor of a performance data transmission device in the first node causes the performance data transmission device to:
obtain performance data relating to the communication over the communication interface, obtain configuration data,
schedule the transmission of performance data and configuration data in a sequence of consecutive reports according to a reporting scheme, said sequence making up a set of reports, and
transmit said reports according to the reporting scheme,
wherein configuration data is only present in a subset of the set of reports, which subset includes at least one report.
